(19) United States
(12) Patent Application Publication
(10) Pub. No.: US 2007/0261080 A1
(43) Pub. Date: Nov. 8, 2007

(54) System of Delivering Interactive Seminars, and Related Method

(75) Inventor: Riccardo Saetti, Cognento (IT)

Correspondence Address: ROBERTS, MLOTKOWSKI & HOBBES, P. O. BOX 10064, MCLEAN, VA, 22102-8064, US

(73) Assignee: Limk Formazionne S.R.L., Cognento (IT)

(21) Appl. No.: 11/575,742

(22) PCT Filed: Sep. 13, 2005
(86) PCT No.: PCT/IT05/00519

§ 371 Date: Apr. 4, 2007

(30) Foreign Application Priority Data
Sep. 22, 2004 (IT) RM2004A000447

(51) Int. Cl. G09B 5/06

(52) U.S. Cl. 725/61

(57) ABSTRACT

The present invention concerns a system of delivering interactive seminars that allows, in particular, the projection of interactive movies, enjoyed by groups of people attending the seminars with the possible supervision of a tutor, apt to modify their own story depending on decisions and behaviours of the audience, the system stimulating the attention of the participants through the stimulus of all the sensory channels controlling the learning process, ensuring a strong involvement of the participants with the maximum reproducibility of the instructive results, the system being extremely efficient, reliable, and simple to use. The present invention further concerns the related method of delivering interactive seminars, and the instruments and the apparatuses of the system.

The present invention concerns a system of delivering interactive seminars that allows, in particular, the projection of interactive movies, enjoyed by groups of people attending the seminars with the possible supervision of a tutor, apt to modify their own story depending on decisions and behaviours of the audience, the system stimulating the attention of the participants through the stimulus of all the sensory channels controlling the learning process, ensuring a strong involvement of the participants with the maximum reproducibility of the instructive results, the system being extremely efficient, reliable, and simple to use.

The present invention further concerns the related method of delivering interactive seminars, and the instruments and the apparatuses of the system.

It is known that training and instructive updating activities are presently essential in both academic field, obviously, and industrial field, including in the latter definition both companies, having personnel involved in technological development and/or personnel involved in marketing and commercialisation of company goods or services, and large homogeneous groups of professionals, such as doctors, lawyers, and engineers. The need for such instructive activities is being increasingly diffusing due to the high dynamicity that presently characterises most of the technological fields and to the high competition among companies, that causes new commercial assistance activities to be created.

In order to maintain its competitiveness, it is therefore necessary for a company (as well as for a research institution such as a school or a university) to continuously carry out training of new personnel, such as agents, representatives, commercial and technical operators, installers (in case of a research institution, new students or researchers), and a continuous instructive updating of the existing personnel (in case of a research institution, researchers and professors, and, in case of institutions operating in the field of territorial public health, medical and paramedical personnel of hospitals and surgeries).

Most of all in medium-large companies or research institutions, comprising some hundreds or even some thousands of employees, such instructive activities may not be easily carried out, due to the large number of instructors needed and the consequent instruction disuniformity, both in time and in contents.

A further drawback of training carried out by means of an instructor is that supplied courses are often not enough pleasant for students, causing a poor attention and assimilation of instructive contents, besides not satisfying, due to the unforeseeable development of a room lesson, those specific aspects, which have to be preliminarily carefully scheduled, that didactic psychology indicates as necessary for maximising the learning level.

Presently available remote training (e.g. through Internet link or through CDROMs storing courses) systems may only partly solve the problem of supplying courses to a plurality of persons according to some correct psychological characteristics, but they suffer from some drawbacks.

These are mainly due to the fact that interactivity allowed to students is rather low, and typically limited to carrying out intermediate and final tests, followed by providing the correct responses to the questions asked by the test, and (possibly except for the final test) by successive section of the training course, the content of which is independent of the specific results of the tests. Possibly, the successive section of the training course may be conditional on passing a minimum mark in the preceding test. In this regard, it has to be taken account of the fact that a high interactivity by students is an essential characteristic for making the learning level maximum.

Similar problems occur in the case when, a company organises, instead of a training course, meeting for promoting a new product or service and/or for disclosing technical and or application information thereof for its own customers or potential customers, meetings where it would be fundamental to obtain a strong involvement of participants in order to allow a precise and complete assimilation of messages.

It is therefore an object of the present invention to allow, in a reliable, simple, and inexpensive way, playing interactive movies conditional on one or more selections made by at least one participant.

It is specific subject matter of the present invention a system of delivering interactive seminars to one or more participants, comprising first electronic processing and controlling means, playing on at least one player apparatus at least one movie comprising a set of sub-movies and one or more selection requesting graphic interfaces, said electronic means being network connected with second electronic means of interaction of said one or more participants, the system being characterised in that said first electronic means plays at least one sequence of two or more of said sub-movies conditional on one or more selections made by at least one participant through said second electronic means, at least one of said one or more selections being made at the end of playing a first sub-movie for selecting a second sub-movie within a sub-set of sub-movies corresponding to the first sub-movie, at least one selection requesting graphic interface corresponding to the first sub-movie being displayed at the end of playing the first sub-movie.

Always according to the invention, said second interaction electronic means may comprise at least one keypad and/or at least one screen and/or at least one telecamera and/or at least one microphone and/or at least one processing logical device.

Still according to the invention, said second interaction electronic means may comprise at least one interaction unit for each one of said one or more participants.

Furthermore according to the invention, said at least one interaction unit may comprise:
an alphanumeric keypad,
a liquid crystal screen,
an infrared ray telecamera,
a microphone, and
a processing logical device to which the alphanumeric keypad, the screen, the telecamera, and the microphone are connected
   said processing logical device controlling said at least one interaction unit and being connected to said network of connection with said first electronic means, so as to send to this at least one signal depending on one or more signals coming from the alphanumeric keypad and/or from the screen and/or from the telecamera and/or from the microphone.

Always according to the invention, said processing logical device may comprise acoustic processing electronic means apt to digitise at least one audio signal coming from the microphone, and to perform operations of gating of said at least one audio signal, so as to at least partially eliminate components thereof different from the components generated by the speech of the related participant.

Still according to the invention, said acoustic processing electronic means may at least partially eliminate the components of said at least one audio signal different from the components generated by the speech of the related participant on the basis of their frequency contents and/or of the amplitude of the related signal.

Always according to the invention, said processing logical device may comprise video processing electronic means apt to digitise at least one video signal coming from the telecamera.

Furthermore according to the invention, said at least one interaction unit may comprise lighting means.

Always according to the invention, said at least one interaction unit may comprises a PDA (Personal Digital Assistant).

Still according to the invention, said network of connection of said second electronic means with said first electronic means may be at least partially a wired network.

Furthermore according to the invention, said network of connection of said second electronic means with said first electronic means may comprise a communications node or “hub”, to which at least one interaction unit is connected through at least one USB port and/or through the Ethernet network, the hub being connected to or integrated into said first electronic means.

Always according to the invention, said network of connection of said second electronic means with said first electronic means may be at least partially a wireless network.

Still according to the invention, said network of connection of said second electronic means with said first electronic means may be at least partially a Bluetooth or Wi-fi wireless network.

Always according to the invention, said at least one interaction unit may communicate with at least one radio concentrator device, provided with an antenna and connected to or integrated into said first electronic means.

Furthermore according to the invention, said network of connection of said second electronic means with said first electronic means may be at least partially a geographically distributed network.

Always according to the invention, said first electronic means may comprise at least one server.

Still according to the invention, said first electronic means may comprise at least two servers connected in a wired and/or wireless network.

Furthermore according to the invention, said network of connection between said at least two servers may be at least partially geographically distributed.

Always according to the invention, said first electronic means may comprise at least one database storing a plurality of audio phrases and/or still images and/or moving images, and said first electronic means may be apt to recognise, on the basis of one or more signals coming from said second electronic means, a context of participation of said one or more participants and to play at least one audio phrase and/or at least one image stored in said at least one database which correspond to the recognised context.

Still according to the invention, the participation contexts which said first electronic means are apt to recognise may comprise the end of playing of said first sub-movie and/or the simultaneous presence of at least two vocal signals generated by corresponding participants and/or a determined verbosity index of at least one participant and/or a determined motility index of at least one participant and/or at least one occurred selection made by a participant.

Furthermore according to the invention, said first electronic means may play said second sub-movie by randomly selecting it within a class of sub-movies of the sub-set of sub-movies corresponding to the first sub-movie, said class corresponding to said one or more selections made by at least one participant through said second electronic means.

Always according to the invention, said first electronic means may be apt to process summarising and/or statistical data of the delivered interactive seminar.

Still according to the invention, said summarising and/or statistical data of the delivered interactive seminar may comprise performances of said one or more participants in making the required selections, in relation to at least one agreement index and/or to at least one response rapidity index and/or to at least one index of appropriateness of the made selections and/or to at least one index of economical cost that the selection would entail in a real situation and/or to at least one majority percentage and/or to at least one verbosity index and/or to at least one motility index and/or to at least one leadership index.

Furthermore according to the invention, said first electronic means may comprise at least one storing device for storing said at least one sequence of two or more of said sub-movies and/or said one or more selections made by at least one participant through said second electronic means and/or at least one signal coming from said second electronic means and/or summarising and/or statistical data of the delivered interactive seminar.

Always according to the invention, said first electronic means may be apt to manage personal data of said one or more participants.

Still according to the invention, said first electronic means may be apt to print summarising and/or statistical data of the delivered interactive seminar on at least one printer.

Furthermore according to the invention, said first electronic means may be apt to configure said second electronic means.

Always according to the invention, said first electronic means may comprise one or more dimmers for controlling one or more lamps.

Still according to the invention, said first electronic means may be apt to control at least one telecamera.

Furthermore according to the invention, said first electronic means may comprise:
a main server, apt to control said player apparatus;
a communications server, apt to communicate with said second interaction electronic means, and
a third server, provided with a microphone and/or an infrared ray telecamera, through which a tutor interacts with the system,
the communications server being connected to the main server and to the third server, the main server playing said at least one sequence of two or more of said sub-movies conditional on one or more selections made by at least one participant, on the basis of one or more signals coming from said second electronic means and routed by the communications server, the main server being apt to play on said player apparatus at least one audio signal and/or at least one video signal coming from the third server and routed by the communications server, the third server receiving through the communications server signals coming from the main server and/or from said second electronic means and playing images and/or sounds corresponding to the received signals on at least one display and/or an acoustic player.

Always according to the invention, the main server may be provided with one or more reading units for high capacity magnetic cartridges and/or one or more DVD player units and/or one or more hard disks storing the interactive movie in digital format.

Still according to the invention, the main server may be apt to display on at least one display at least one selectable graphic interface provided with one or more selectable fields and/or squares for controlling playing of said at least one sequence of two or more of said sub-movies.

Always according to the invention, the communications server may be apt to display on at least one display at least one selectable graphic interface provided with one or more selectable fields and/or squares for controlling said second electronic means and/or the main server and/or the third server.

Furthermore according to the invention, the main server and the communications server may be apt to be alternatively connected to a same display through an electronic switching device.

Always according to the invention, the third server may play on said at least one display and/or said at least one acoustic player said images corresponding to the signals received according to a plurality of selectable graphic interfaces, preferably comprising one or more selectable fields and/or squares.

Still according to the invention, the third server may be provided with at least one memory unit containing a, preferably low-resolution, copy of the interactive movie of which it displays the images in synchronism with what played by the main server on said at least one player apparatus.

Furthermore according to the invention, said at least one player apparatus may comprise at least one display and at least one acoustic player.

Always according to the invention, said at least one player apparatus may comprise at least one projector, apt to project images onto at least one screen, and one or more speakers for diffusing audio signals.

Still according to the invention, the system may comprise at least two interaction units arranged according to a horseshoe open towards at least one screen.

Furthermore according to the invention, at least one projector may be a liquid crystal digital video projector.

Always according to the invention, at least one projector may operate in retro-projection behind at least one screen.

It is also specific subject matter of the present invention an interaction apparatus, comprising at least one keypad and/or at least one screen and/or at least one telecamera and/or at least one microphone and/or at least one processing logical device, that is apt to be used as interaction unit in the previously described system of delivering interactive seminars.

It is still specific subject matter of the present invention a server computer, apt to control a player apparatus, that is apt to be used as main server in the previously described system of delivering interactive seminars.

It is further specific subject matter of the present invention a server computer, apt to communicate with interaction electronic means, that is apt to be used as communications server in the previously described system of delivering interactive seminars.

It is always specific subject matter of the present invention a server computer, provided with microphone and/or infrared ray telecamera, that is apt to be used as third server in the previously described system of delivering interactive seminars.

It is also specific subject matter of the present invention a method of delivering interactive seminars to one or more participants, comprising:
controlling through first processing and controlling electronic means the playing on at least one player apparatus of at least one movie comprising a set of sub-movies and one or more selection requesting graphic interfaces;
   the method being characterised in that at least one sequence of two or more of said sub-movies is conditional on one or more selections made by at least one participant through second electronic means connected to said first electronic means, at least one of said one or more selections being made at the end of playing of a first sub-movie for selecting a second sub-movie within a sub-set of sub-movies corresponding to the first sub-movie, at least one selection requesting graphic interface corresponding to the first sub-movie being displayed at the end of playing of the first sub-movie.

Always according to the invention, said first electronic means may perform the following steps:
periodically controlling, at a rate equal to a period CP, said one or more signals coming from said second electronic means;
processing said controlled one or more signals for recognising a corresponding context, and, in the case when the recognised context belongs to a class of contexts to be subject to periodical control:
randomly or pseudo-randomly selecting at least one audio phrase and/or at least one image to play within a class of audio phrases and/or images corresponding to the recognised context.

Still according to the invention, said at least one audio phrase and/or at least one image to play may be selected on the basis of an historical memory of the previously played audio phrases and/or images.

Furthermore according to the invention, said at least one audio phrase and/or at least one image to play may be selected in the case when said first electronic means has randomly or pseudo-randomly checked whether to play at least one audio phrase and/or at least one image corresponding to the context or not.

Always according to the invention, in the case when said first electronic means recognises the participation context as belonging to a class of contexts to be subject to immediate control, said first electronic means may select at least one audio phrase and/or at least one image to play within a class of audio phrases and/or images corresponding to the recognised context.

Still according to the invention, the context recognised as belonging to a class of contexts to be subject to immediate control may be a context in which all said one or more participants have made at least one selection, said first electronic means reproducing the results of the selections.

Furthermore according to the invention, the context recognised as belonging to a class of contexts to be subject to immediate control may be a context in which a maximum time has passed since the display of said at least one selection requesting graphic interface, said first electronic means reproducing the results of the selections.

Always according to the invention, for at least one participant who has made no selection, said first electronic means may automatically generate a selection, randomly and/or on the basis of at least one previously made selection.

Still according to the invention, said first electronic means may reproduce the results of the selections in the case when a significant majority of selections exists, otherwise it may select at least one audio phrase and/or at least one image to play for inviting to make new selections.

Furthermore according to the invention, said first electronic means may be apt to calculate, on the basis of one or more signals coming from said second electronic means, at least one verbosity index of at least one participant.

Always according to the invention, said at least one verbosity index of at least one participant may be calculated as a function of at least one parameter selected from the group comprising:
the time average of duration,
the amplitude,
the total duration,
   of at least one audio signal generated by the speeches of said at least one participant.

Still according to the invention, said time average of duration of said at least one audio signal generated by the speeches of said at least one participant may be calculated within at least one time window of duration W.

Furthermore according to the invention, said at least one verbosity index of at least one participant may be calculated as a function of a mean and/or total number of the speeches of said at least one participant.

Always according to the invention, said at least one verbosity index of at least one participant may be calculated as a function of a time delay D, equal to the time passed since the last speech of said at least one participant.

Still according to the invention, said at least one verbosity index of said at least one participant may be calculated as the difference of said time delay D with respect to an average DM of the time delays of said one or more participants.

Furthermore according to the invention, said at least one audio signal generated by the speeches of said at least one participant may be neglected if its intensity is lower than a minimum threshold A.

Always according to the invention, a speech of said at least one participant may be neglected if its duration is shorter than a minimum time threshold T1, preferably equal to 4 seconds.

Still according to the invention, one or more interruptions of said at least one audio signal occurring within a speech of said at least one participant may be neglected if their duration is shorter than a maximum time threshold T2, preferably equal to 3 seconds.

Furthermore according to the invention, said at least one audio signal generated by the speeches of said at least one participant may be processed so as to subtract an audio signal played by said at least one player apparatus therefrom.

Always according to the invention, said at least one audio signal generated by the speeches of said at least one participant may be processed on the basis of its frequency contents and/or its amplitude.

Still according to the invention, said first electronic means may be apt to perform a step of learning of the frequency spectrum and/or the mean amplitude of said at least one audio signal generated by the speeches of said at least one participant.

Furthermore according to the invention, said first electronic means may be apt to calculate, on the basis of one or more signals coming from said second electronic means, at least one motility index of at least one participant.

Always according to the invention, said at least one motility index of at least one participant may be calculated, starting from the images detected from a telecamera taking said at least one participant, depending on at least one difference, between two successive instant images, of at least one value depending on at least one parameter selected from the group comprising:
chrominance,
luminance, and
intensity

of at least one video signal generated by said telecamera.

Still according to the invention, the calculation of said at least one motility index of at least one participant may comprise the following steps:

A. for each instant image, the instant image is subdivided into areas of N×N pixels, wherein preferably N=8 or 16;

B. for each area of the instant image under consideration:

A.1 calculating a value depending on the average and/or the sum of at least one of the three signals of chrominance, luminance, and intensity;

A.2 calculating the difference VD between the value calculated in step A.1 and the value of the corresponding area of the instant image immediately preceding that under consideration;

A.3 in the case When the difference calculated in step A.2 is higher than a minimum threshold value MV, considering the corresponding area as a mobile area;

C. calculating a value of instant motility of the participant depending on the number of mobile areas of the instant image under consideration;

D. calculating a value of whole motility of the participant depending on the value of instant motility of the participant calculated in step C.

Furthermore according to the invention, said instant motility value of the participant calculated in step C may be equal to the number of mobile areas of the instant image under consideration.

Always according to the invention, said whole motility value of the participant calculated in step D may be equal to the time average of the instant motility.

Still according to the invention, said at least one motility index of said at least one participant may be calculated as the difference of a whole motility of said at least one participant with respect to an average MM of the whole motilities of said one or more participants.

Furthermore according to the invention, said at least one video signal generated by said telecamera may be processed so as to subtract the background of said images therefrom.

Always according to the invention, said at least one video signal generated by said telecamera may be processed so as to track at least one portion of said images occupied by said at least one participant.

Still according to the invention, said first electronic means may be apt to perform a step of learning of said at least one video signal generated by said telecamera is processed so as to recognise at least one portion of said images occupied by said at least one participant.

The present invention will now be described, by way of illustration and not by way of limitation, according to its preferred embodiment, by particularly referring to the Figures of the enclosed drawings, in which:

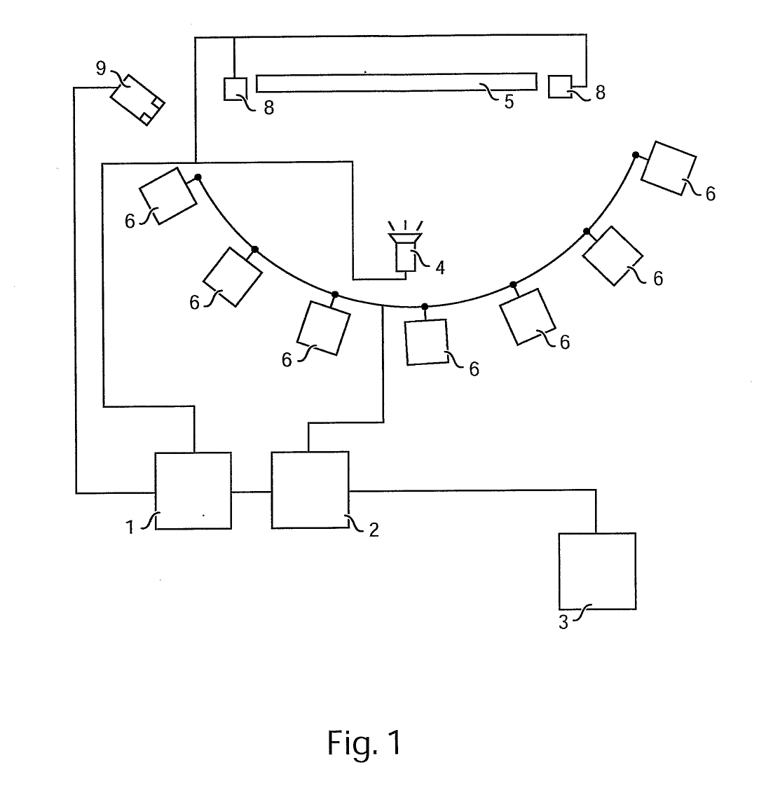

FIG. 1 schematically shows a preferred embodiment of the system according to the invention;

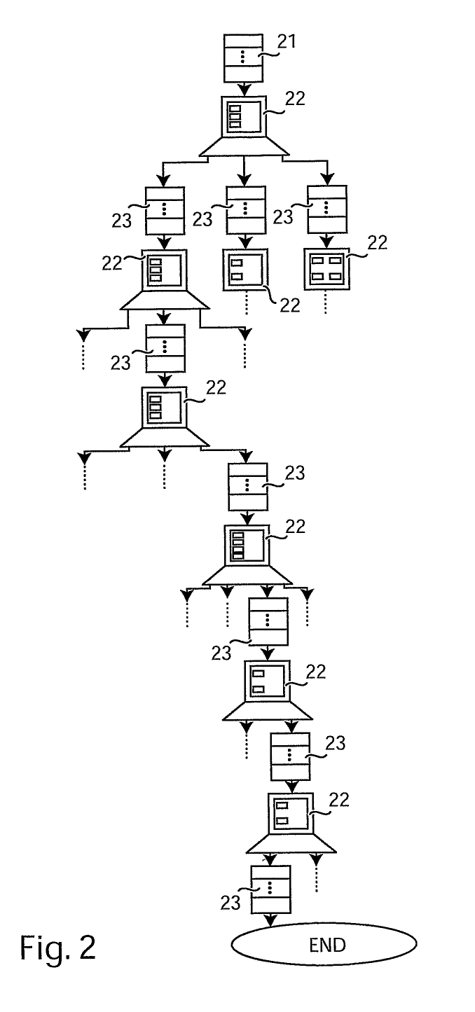

FIG. 2 schematically shows the various steps of playing an interactive movie in the system of FIG. 1;

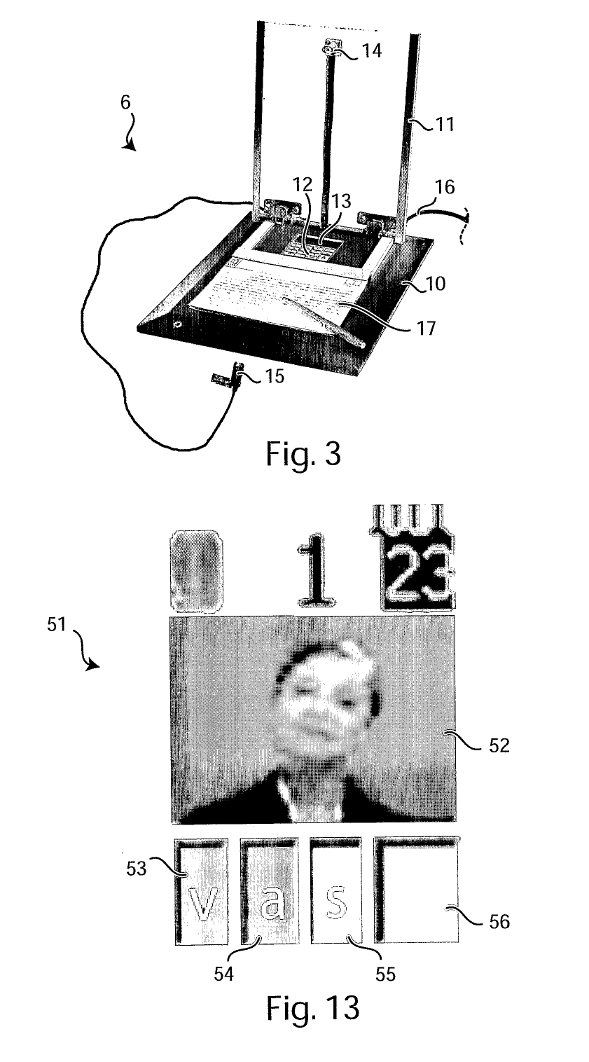

FIG. 3 shows an interaction unit of the system of FIG. 1;

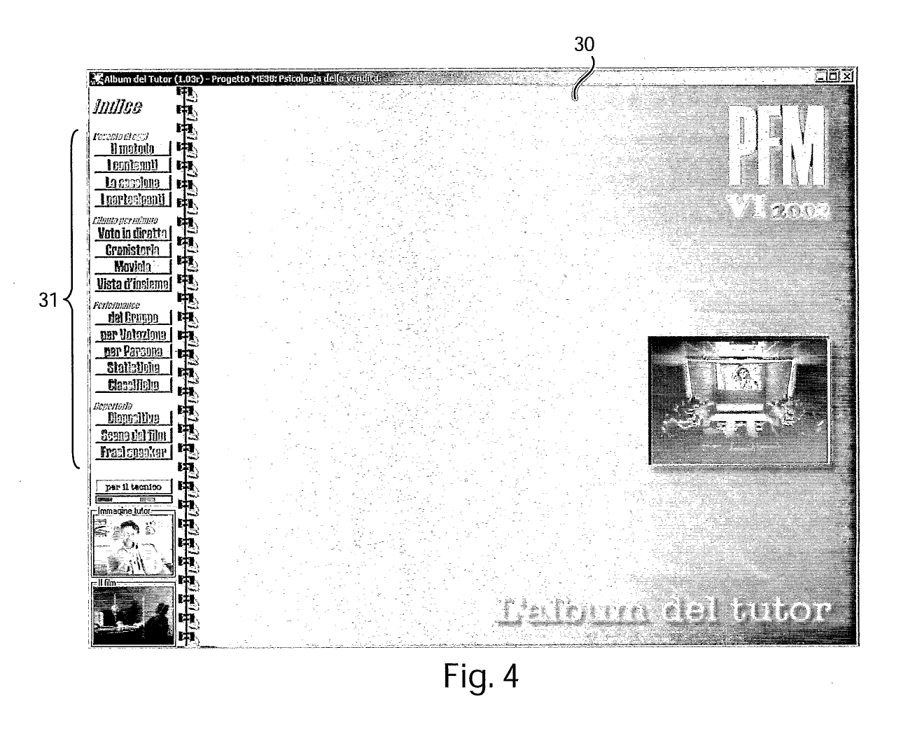

FIGS. 4-9 show six graphic interfaces displayed by the third server of the system of FIG. 1;

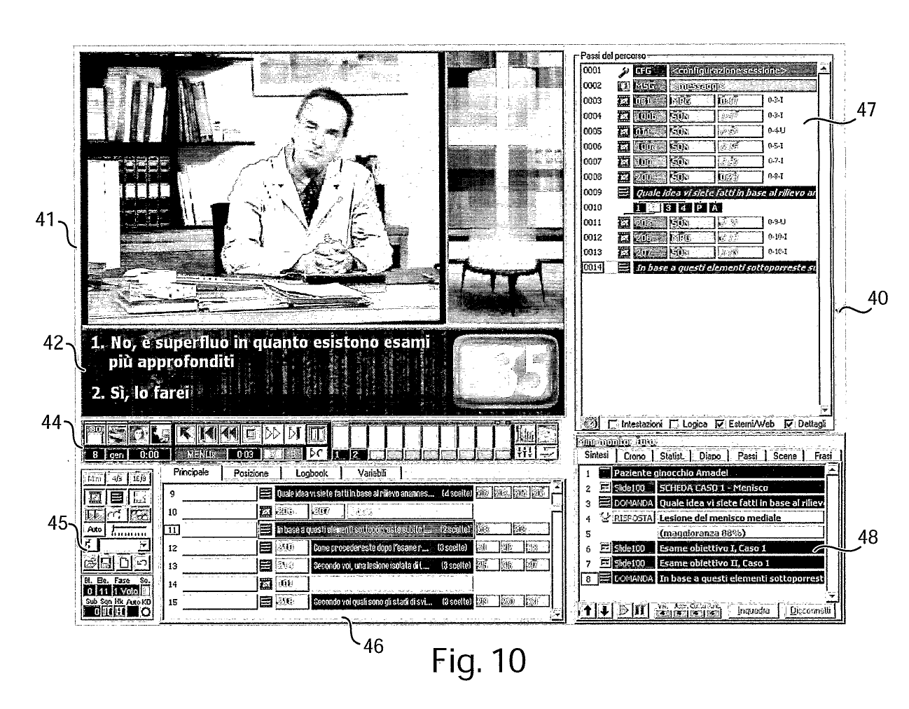

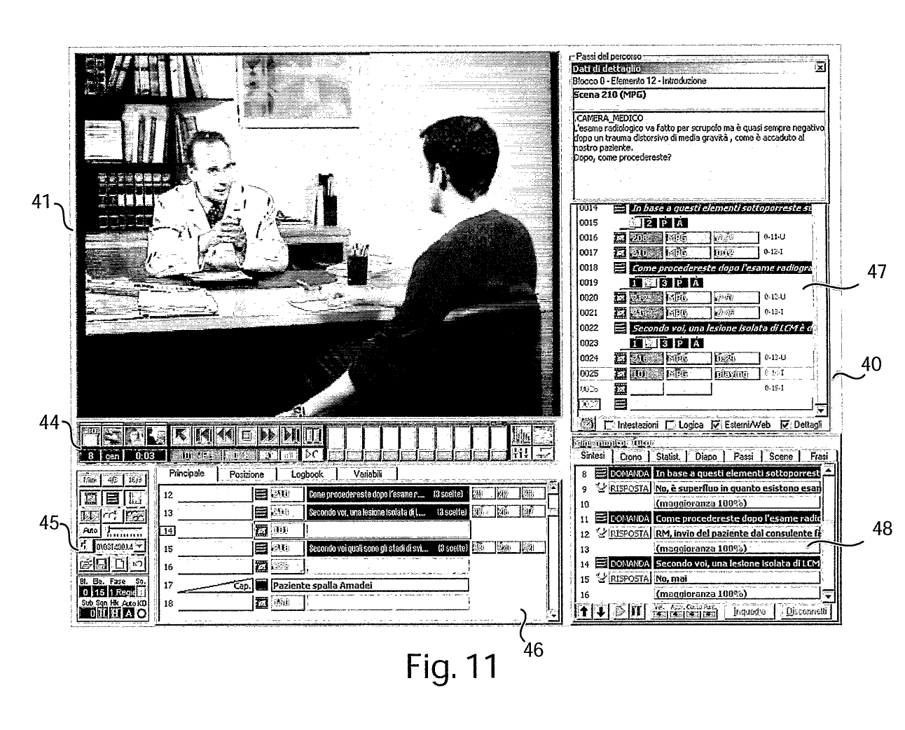

FIGS. 10 and 11 show two graphic interfaces displayed by the main server of the system of FIG. 1;

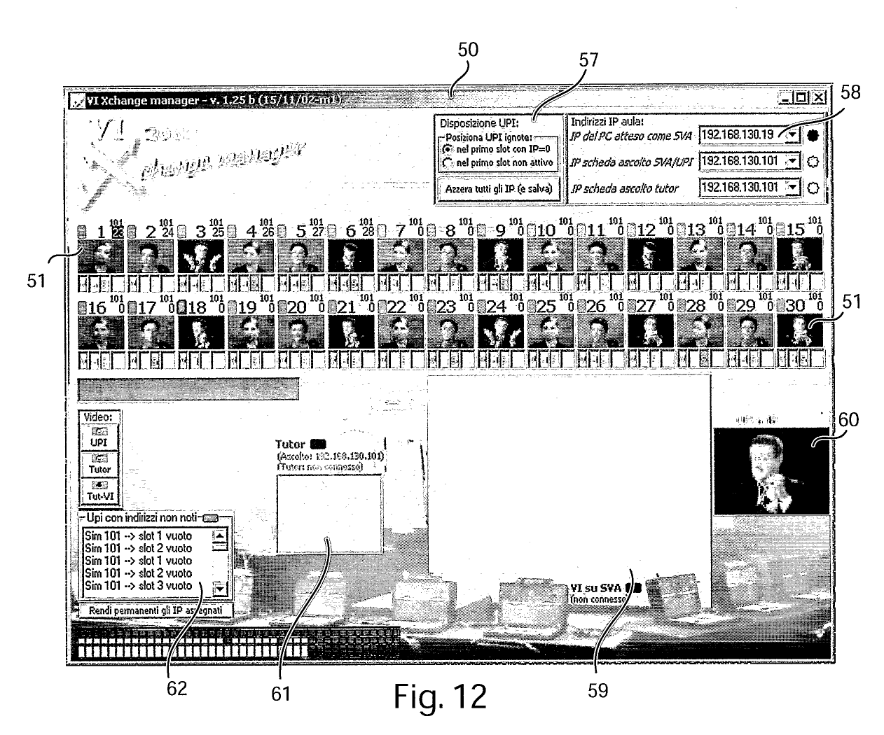

FIG. 12 shows a graphic interface displayed by the communications server of the system of FIG. 1;

FIG. 13 shows a particular of the interface of FIG. 12; and

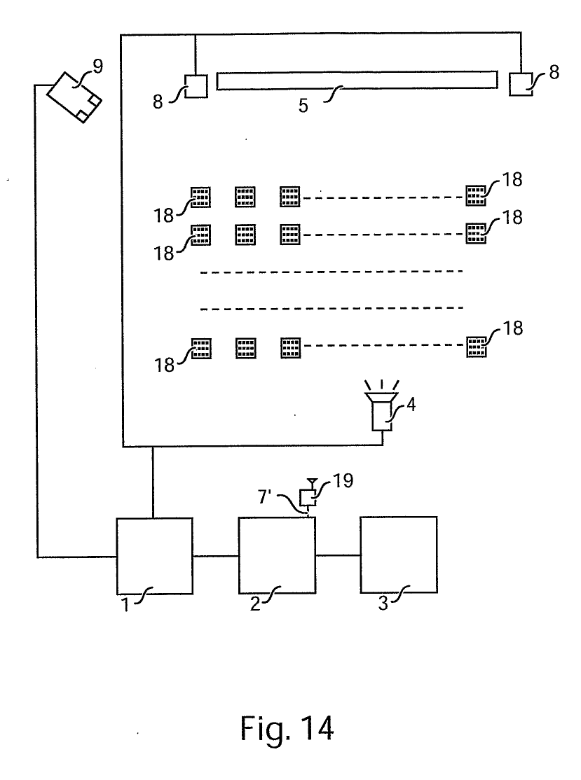

FIG. 14 schematically shows a further embodiment of the system according to the invention.

In the following of the description, same references will be used for indicating alike elements in the Figures.

The system according to the invention, while it supplies an interactive movie, analyses and measures reactions, decisions and behaviours of the participants. In this way, the system is further apt to detect on a large scale information about the instruction level of the participants and/or the market trends, up to arrive to the possibility of analysing data of an individual (if authorised).

In particular, depending on the situations, the number of the participants in interactive seminars delivered by the system may be highly variable, from some hundreds, as on the occasion of exhibition and/or conference events, down to small groups of 3-30 people, diffusely reached on the territory. Some embodiments of the system according to the invention may also deliver seminars to only one person, such as in case of “boxes” or “totems” installed in exhibition stands or in transit places.

Preferably, the system according to the invention comprises instruments and apparatuses which are easily movable and rapidly installable in not prepared rooms. In particular, as it will be better shown later, the system comprises computerised apparatuses, for the automatic control of interactive movies, which interacts with electronic devices, such as voting keypads, sensors, microphones, preferably infrared ray telecameras, which detects decisions and behaviours of the audience of participants.

Furthermore, some embodiments of the system may also carry out a network connection among groups of participants placed in geographically distributed rooms.

FIG. 1 shows a preferred embodiment of the system according to the invention, comprising a first server computer or main server 1, connected to a second communications server 2, in turn connected to a third server 3. Connections among the three servers 1, 2 and 3 (which are preferably substantially personal computers) may be, for instance, carried out through a LAN network and/or the Internet network.

The first server 1 controls a projector 4, preferably of known type, that may be not part of the system according to the invention, for projecting onto a screen 5 (preferably a large screen) the still or moving images of the instructive seminar, preferably comprising video images of an interactive movie. In particular, the projector 4 may also operate in retro-projection behind the screen 5. Obviously, the first server 1 also controls one or more speakers 8 for diffusing audio signals.

Moreover, the system comprises a plurality of interaction units 6, each one intended for a corresponding participant of the seminar, and connected to the second server 2 through a network 7. In particular, when the network 7 is a wired network, the interaction units 6 are connected through USB ports (or through Ethernet network) to a communications node or “hub”, in turn connected to (or even integrated into) the communications server 2. Preferably, the interaction units 6 are arranged according to a horseshoe open towards the screen 5, in order to transmit to the participants a high sensation of “immersion” and involvement into the projected images (also thanks to the dark in the room during projections, and to an adequate diffusion of the audio through the speakers 8). Each interaction unit 6 is preferably provided with:
detection sensors and interaction devices, such as voting keypads, microphones and telecameras, through which the corresponding participant may interact (with the system and with the other participants) and his/her behaviour may be monitored, and
devices for controlling the unit 6 and for processing signals coming from the detection sensors and from the interaction devices.

As said, the main server 1, preferably comprising a personal computer belonging to the highest class of processing power, controls the projection of the images of the instructive seminar onto the screen 5, in particular the images of an interactive movie on which the delivery of the interactive seminar by the system according to the invention is substantially based.

The interactive movie reacts to decisions and behaviours of the participants/students and consequently shows different successive sub-movies illustrating the consequences of the made selections. By way of example, in case of seminars intended for medical instruction, professional situations, typical of the daily practice, are shown, simultaneously analysing and stressing (with the possible aid, for instance, of tables, slides, graphic animations) both its theoretical and conceptual aspects, and its purely practical aspects, usual characters and protagonists of a medical work environment being capable to be shown “in action”.

With reference to FIG. 2, it may be observed that, after an introductory sub-movie 21, the movie continues by alternating requests 22 for selection by the participants (for instance for selecting a possible therapeutic choice following symptoms described by a character-patient of the movie) and sub-movies 23 depending on the decisions taken by the group of participants/students. In particular, the main server 1, on the basis of signals coming from the interaction units 6 and collected by the second communications server 2, controls the sequence of sub-movies conditional on the selections of the participants.

Each time the group is asked a question (preferably presented in the form of a menu 22 of options illustrated by a character of the movie), the group of students further has the faculty to discuss, for a period of time not longer than a predetermined maximum, about which selection is the best one. In particular, by evaluating, for instance, the level of oral participation of each participant on the basis of the signals coming from the microphones of the interaction units 6, the system is capable to control the discussion, stimulating it, moderating it, giving time if the group shows such need, and making time limits be met. The managing and moderating activity carried out by the system is made possible by the fact that the main server 1 is provided with at least one database storing some thousands of digitised phrases suitable to the purpose (recorded from the voice of a professional speaker) and/or corresponding video scenes of a character appearing as controlling the discussion, which the system uses by selecting the appropriate ones depending on the different contexts automatically detected by the interaction units 6. For instance, the main server 1 may randomly select a phrase and/or a scene from a class of phrases and/or scenes corresponding to a context recognised by the system (phrases of the type: “you can speak to each other about that”, “no one of you speaks yet”, “speak one at a time”, “sirs, do not speak all together”, “no one of you has voted yet”, “only one person has not yet voted: come on!”, “I cannot wait more, let us go on”, “this time you have reached unanimity”, “do not be hasty in voting”); in this way, the main server 1 may keep a sort of historical memory of the already said phrases, so as not to always repeat the same phrase for the same context. This makes possible to control the discussion in a completely automatised manner, without the need for any human intervention, for instance by inviting not to simultaneously speak, when the microphones of two or more units 6 detect that the corresponding participants are simultaneously speaking, and also stimulating the participation of a participant (identified through a “nickname” or his/her real name pronounced by a synthesiser) who has not been sufficiently involved in the discussion.

Preferably, the main server 1 executes the following process:
it periodically, at a rate equal to a period CP, preferably equal to 15 seconds, controls the status of the audio sensors and/or the status of the video sensors and/or the status of the projection onto the screen 4 and/or the status of the voting keypads;
it recognises the context corresponding to the checks made (for instance it recognises an indecision context when it has verified that no one or very few participants have carried out voting selections, an indecision context having already occurred);
in the case the recognised context provides the possibility of pronouncing a phrase and/or projecting a corresponding scene, it randomly or pseudo-randomly (i.e. with non equi-probable selection) checks whether or not pronouncing a phrase and/or projecting a corresponding scene;
in the case the preceding check gives a positive outcome, it selects the class of phrases and/or scene corresponding to the recognised context (for instance, the class corresponding to the context of further indecision); and
it randomly or pseudo-randomly (i.e. with non equi-probable selection) selects the phrase to say and/or the scene to project (for instance the phrase “I again see you indecisive”) on the basis of the historical memory, whereby, for instance, the previously pronounced phrases (for instance the phrase “no one has voted: come on!”) and/or the previously projected scenes of the same class are marked with a flag (which is reset when all the phrases and/or scenes of the class have been used).

In particular, under the occurrence of certain specific contexts, such as for instance the simultaneousness of speaking participants or at the end of voting, the system advantageously provides that the main server 1 always and immediately (that is without waiting for the expiry of the period CP) pronounces a phrase and/or projects each time a scene of the class corresponding to the specific recognised context (for instance: “for the first time you have reached unanimousity”, “there are two choices in parity: speak about it again”, “there are two choices in parity: let us make the character of the movie choose”, “there is no agreement this time”).

During the discussion, each one of the students has the faculty to make his/her own decision by using a voting keypad of the corresponding interaction unit 6. Preferably, students are allowed to change their own decisions, for instance following arguments arising during the discussion. When all have expressed their selections, or when a maximum time has lapsed in case of abstentions, the outcome is shown to everybody, through the projection of a slide processed by the main server 1. If a significant majority exists, the interactive movie continues with the successive sub-movie corresponding to the selection decided by the group. If a significant majority does not exist, the main server 1, still through the selection of suitable pre-recorded phrases, invites to re-open the discussion, and stimulates the group to reach a consensus. Preferably, in the case when problems in detecting selections of all the participants occurs, for example for a technical malfunction, the main server 1 automatically generates the selections of the participants which have not expressed any vote, for instance randomly and/or on the basis of the previously made selections.

Once a decision has been expressed, the corresponding successive sub-movie 23 shows the consequences of the same decision. This is made possible by the fact that, during the preparation of the interactive movie, a sub-movie 23 has been provided and taken for each possible “branch” in which the logical tree (such as those depicted in FIG. 2) corresponding to the interactive movie.

In particular, the sub-movies 23 following the several decisional “branches” may be of various types, such as for instance sub-movies wherein protagonists, performing correct actions, positively achieve results, or, performing incorrect or doubtful actions, consequently undergo negative effects. From these incorrect or doubtful situations, the logical development of the interactive movie may advantageously provides a series of theoretical and practical movie contributions apt to lead the students towards the right route, documenting in a reasoned way presuppositions and motives.

The evolution of so developed “events” allows itself to be followed along time, up to a final evaluation of the result. In the space of some tenths of minutes of virtual time it may be hence completed a whole subject course, that in a professional life sometimes lasts even weeks or months.

During the flow of the interactive movie, along with an increasing familiarity of the group of students with the system according to the invention, in particular with the interaction units 6, a progressive reciprocal knowledge of the tendencies of people forms, that often results, in case of good agreement, in very fast response times in successive decision moments, so reaching a rate of development of virtual events more and more similar to the real one.

The intrinsic variability of the real world is so reproduced by the seminar delivered by the system according to the invention, causing different responses, even in similar situations, by the characters of the interactive movie. It is also possible that the same character, in different moments, may answer in different ways. In order to introduce into the simulation also this type of realism, in the main server 1 it is possible to set the probabilities with which, according to experience or scientific literature of each specific subject, the different reactions of the character may be expressed. Using a randomising technique, the main server 1 provides to reproduce the variability, satisfying as much as possible the frequencies with which it manifests itself in reality. This may allow students to exercise in the practical management of all the different responses and situations which they may face in the future practice of their work.

Still with reference to FIG. 1, the main server 1 is the logical manager of the interactive movie. It is preferably provided with two reading units, or drives, for high capacity magnetic cartridges (preferably Iomega® Jaz) storing the interactive movie in digital format, of which it is capable to play in real time the various selected sub-movies sending the related signal to the projector 4, preferably a liquid crystal digital video projector. Alternatively or in addition to the drives for magnetic cartridges, DVD players or even a (internal or removable) high speed hard disk storing one or more movie to project may be used.

As said, the logic of the interactive movie provides that the choice of the different sub-movies to successively project depends on the selections made by the group of students, preferably through the voting keypads of the interaction unit 6. Through the routing action operated by the communications server 2, these selections reach the main server 1 that logically processes them.

Moreover, at least part of the information detected by the interaction units 6 through infrared ray telecameras and microphones, related to verbosity, to motility and, hence, to the participation of the individual participants, are routed by the communications server 2 towards the main server 1 that processes them for automatically controlling and moderating moments of discussion as described above (possibly sending the results of processing to the third server 3 through the communications server 2); alternatively, at least part of the information detected by the interaction units 6 through infrared ray telecameras and microphones, related to verbosity and motility may be processed by the third server 3 that sends them to the main server 1 through the communications server 2, and/or they may be at least partially processed by the communications server 2 that sends them to the main server 1 and to the third server 3. In other words, processing of data coming from the interaction units 6, specifically audio and video data, may be at least partially performed by the main server 1 and/or by the communications server 2 and/or at least partially by a logical device with which the same interaction unit 6 is provided. In particular, in the case when the communications server 2 performs a processing about verbosity and/or motility of the individual participants, this processing may be examined by an operator for checking the correct operation of microphones and telecameras of the interaction units 6.

Preferably, the verbosity of each participant is estimated as the time average of the duration (or possibly of the speech signal amplitude) of the speeches in which the amplitude of the detected audio signal is higher than a minimum threshold A (excluding the audio signals not considerable as a speech, such as signals due to cough and background noise, which are distinguishable for instance on the basis of their frequency contents and/or their amplitude, most of all in the case when an initial step of learning the frequency spectrum and/or the mean amplitude of the voices of the participant has been performed). Still more preferably, a speech is considered as such when its duration is not shorter than a minimum time threshold T1, for instance 4 seconds; speeches shorter than this time threshold T1 are not considered for the evaluation of verbosity. Possibly, the time average is calculated in time windows of duration W, and it may be also dynamically updated. Preferably, the audio signal coming from the microphone detecting the speech of the participant (or of the tutor) may be processed so as to subtract the audio signal of the interactive movie (that could be, for instance, input in the microphone during the discussion among the participants) therefrom.

Alternatively, verbosity could be calculated as the total duration of the significant speeches of the participant, or as the (mean or total) number of the significant speeches, considering for instance as significant speeches those speeches in which the amplitude of the detected audio signal is higher than the minimum threshold A, the whole duration of which has been longer than the minimum threshold T1, during which no interruption longer than a maximum threshold T2, preferably shorter than the minimum threshold T1 (T2<T1), still more preferably equal to 3 seconds (T2=3 seconds), has occurred.

A further indication of the verbosity, i.e. of the participation of the students to the seminar, may be given by a time delay D, equal to the time since the participant does not make a (possibly significant) speech. In this case, the system (namely, the main server 1 and/or the communications server 2 and/or the third server 3) may further process an average DM of the delays of the participants, indicating for each participant whether the corresponding delay D is longer or shorter than the average DM.

Preferably, the motility of each participant is estimated on the basis of the images detected by the corresponding telecamera according to the following method:

A. for each instant image, the instant image is subdivided into areas of N×N pixels (preferably N=8 or 16);

B. for each area of the instant image under consideration:

A.1 calculating a value depending on the average and/or the sum of at least one of the three signals of chrominance, luminance, and intensity;

A.2 calculating the difference VD between the value calculated in step A.1 and the value of the corresponding area of the instant image immediately preceding the one under consideration;

A.3 in the case when the difference calculated in step A.2 is higher than a minimum threshold value MV, considering the corresponding area as a mobile area;

C. calculating a value of instant motility of the participant depending on the number of mobile areas of the instant image under consideration (for instance, the instant motility may be equal to the number of mobile areas);

D. calculating a value of whole motility of the participant depending on the value of instant motility of the participant calculated in step C (for instance, the whole motility of the participant may be equal to the time average of the instant motility).

In this case, the system (namely, the main server 1 and/or the communications server 2 and/or the third server 3) may further process an average MM of the motility of the participants, indicating for each participant whether the corresponding motility is higher or lower than the average MM, preferably of a percentage at least equal to 15%, still more preferably at least equal to 18%.

Upon recognition of a context of high (or too low) motility of the participants, the main server 1 could also pronounce a phrase and/or project a scene belonging to a class corresponding to the context (for instance, respectively: “I see you a little bit agitated” or “I see you a little bit still”).

The system may further calculate the motility of the participants by processing the image detected by the corresponding telecamera, for instance by subtracting the background. Preferably, such further analysis is performed by using neural networks apt to discriminate between the side movements of the participant and passage of a person behind the participant.

The main server 1 also provides for a series of service operations, such as managing personal data of the seminar participants, and acquiring signals of a panoramic telecamera 9 taking a panning shot of the group of seminar participants.

The communications server 2 receives, via network 7, all the data coming from the interaction units 6. The network 7 may be also at least partially wireless, for instance in the case when the voting keypads of the units 6 are two-ways radio devices. Moreover, the network 7 may be also at least partially geographically distributed, that is at least part of the interaction units 6 may be remotely connected. The server 2 further communicates to the interaction units 6 all the information related to the session in progress (for instance: time, phase, available selections to be made with the voting keypad) so as to maintain a continuous and permanent synchronisation among all the system components.

The communications server 2 ensures the bidirectional (possibly remote) exchange of information with the main server 1 and with the third server 3, that, as it will be shown later, is intended for a tutor. Preferably, all the communications occur through an Ethernet network connection, using TCP/IP protocol.

The communications server 2 also provides for concentrating and memorising all the data recorded during each seminar, and for making prints of all the reports and statistics at the end of the seminar, through a suitable printer. By way of example, the communications server 2 may print a report containing the selections made by each participant, compared with the selections of the majority (i.e. the ones which have effectively determined the route followed during the session), that may be given, along with a certificate of participation, to each participant at the end of the seminar.

The communications server 2 is further preferably provided with a board for telecommunications, still more preferably ISDN and/or ADSL and/or UMTS, that makes possible the remote connection with the third server 3 of the tutor or with a computer of a further teacher, ensuring all the same functions of exchange of data (included the video ones) which are possible with a tutor being present in the room.

FIG. 3 shows a preferred embodiment of an interaction unit 6 of the system according to the invention, that substantially comprises a base 10 upon which a transparent plastic material, preferably plexiglass, cover 11 is hinged, so that, even when open, it does not hinder the related participant from having a sufficient visibility of the screen 5 and of the other participants. The unit 6 is provided with:
a voting keypad 12 and a small liquid crystal screen 13, placed onto the base 10,
an infrared ray telecamera 14, placed onto the cover 11, and
a microphone 15.

The keypad 12, the screen 13, the telecamera 14, and the microphone 15 are connected to a logical device, not shown, controlling the interaction unit 6 and processing data, that, through a cable 16, is connected to the network 7 linking to the communications server 2. Preferably, the logical device comprises a microprocessor and a memory unit.

The voting keypad 12 is preferably provided with alphanumeric keys corresponding to the digits 0 to 9 and to the letters “A” to “D”, for allowing the participants to make the selections proposed by the interactive movie. This keypad 12 also comprises a key for requesting replay, i.e. the repetition of sub-movies possibly not completely understood by anyone of the students. The small liquid crystal screen 13 (that is moreover not indispensable) displays the selections made through the keypad 12, besides possible informative messages, related to the status of the unit 6 (for instance, in case of malfunctions) and/or coming from the main server 1.

The microphone 15, of the clip type, is applicable to the participant clothes, or it may be closed around the participant neck through a string, in order to make the student naturalness as maximum as possible, so that the students are not conditioned, during the discussion, by the otherwise visible and cumbersome presence of a conventional microphone. The logical device of the unit 6 comprises a board for digitising the audio signals coming from the microphone 15, and an electronic gating circuit, capable to neglect sound sources different from the speech of the same participant (as, for instance, the interactive movie audio input or the tutor speech); by way of example, such sound sources may be excluded on the basis of their frequency contents and/or of the amplitude of the related signal. Preferably, the audio signal is sent in two copies to the communications server 2. The microphone 15 is preferably wired to the logical device of the related unit 6; other embodiments of the system according to the invention may provide that the microphone 15 of the interaction units 6 is connected to the related unit 6 (and/or to the main server 1) via radio instead of via wire (as also the microphone with which the third server 3 is provided, as it will be shown later).

The infrared ray telecamera 14 is advantageously placed onto the cover 11 so as to take an image in close-up of the student (also thanks to the adjustment of the hinged cover 11), whom image is sent to the communications server 2 and then routed by the latter towards the main server 1 for its projection onto the screen 5, and/or to the third server 3, and/or to the video recorder for storing the seminar. This allows the tutor operating at the third server 3 to exploit the projection times for increasing the visual knowledge of his/her own students. In particular, the logical device of the unit 6 comprises a board for digitising the video signals coming from the telecamera 14.

Advantageously, each interaction unit 6 may be contained within a wood and leather housing, closable as a box in order to facilitate its transport, apt to minimise the uneasiness of students possibly not accustomed to use informatics instruments. In particular, the base 10 may also house a notebook 17. Moreover, each interaction unit 6 may comprise means for local lighting apt to light the base 10 up making it visible even in conditions of dark in the room.

Other embodiments of the system according to the invention may comprise as interaction unit 6 a PDA (Personal Digital Assistant), preferably connected to the communications server 2 through Bluetooth or Wi-fi wireless technology.

The tutor operates at the third server 3, still provided with microphone and infrared ray telecamera (not shown) through which the tutor is able to interact with the participants. The third server 3 receives from the communications server 2 all the information coming from the main server 1 and from the interaction units 6, displaying them on a display of the third server 3, preferably arranging them according to a plurality of interfaces which, as shown in FIG. 4, are selectable by the tutor starting from a main interface 30 provided with an index comprising a plurality 31 of selectable buttons.

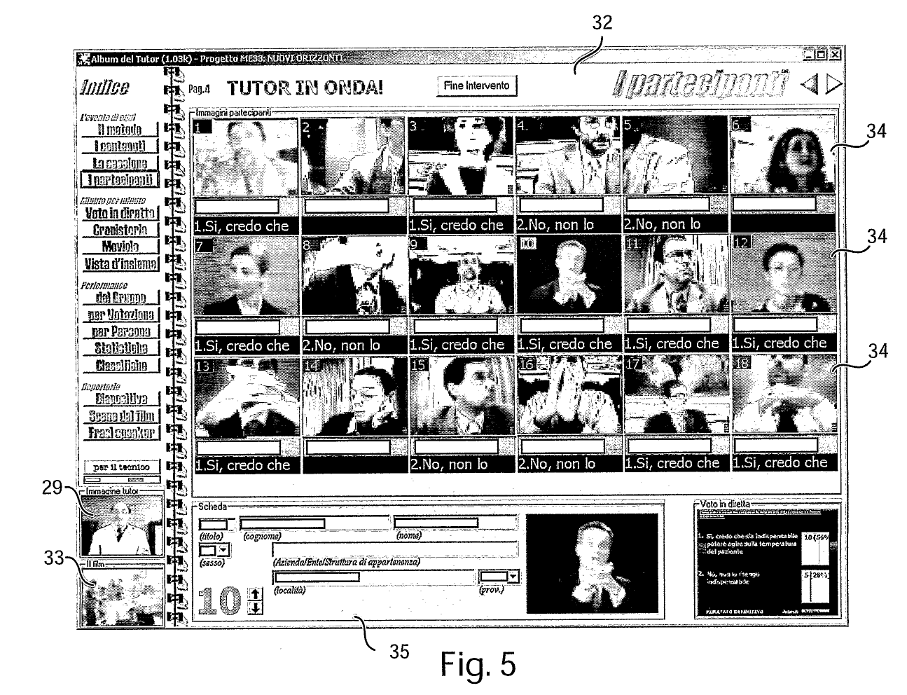

With reference to FIG. 5, this allows the tutor to select an interface 32 showing in a square 29 images related to the same tutor coming from the third server 3, in a square 33 the interactive movie being projected, and in an array of squares 34 all simultaneously the participant faces taken by the telecameras 14 of the interaction units 6, also selecting in a specific portion 35 data and images related to one of the participants possibly selected by the tutor, for instance through a click of the mouse onto the corresponding square 34. In particular, the squares 29 and 33 are preferably always present on all the interfaces selectable by the tutor.

Advantageously, the third server 3 is provided with a memory unit containing a, preferably low-resolution, copy of the interactive movie of which the images are shown synchronously with what projected by the main server 1 onto the screen 5. To this end, the communications server 2 sends to the third server 3 an identification code of the sub-movie 21 or 23 or of the menu 22 that in that moment is being projected by the main server 1. In a similar way, when the tutor wishes to make a specific sub-movie or another sequence of still or moving images be projected, the third server 3 sends to the communications server 2 the related identification code that is sent by the latter to the main server 1 for projecting the corresponding contents onto the screen 5.

During discussions, the specific portion 35 automatically shows in particular the face of the participant speaking in each moment. Other embodiments of the system according to the invention may provide that the squares 34 showing the participant faces are further provided with analog bars (similar to the ones which will be described with reference to FIG. 13), indicating in real time the grade of verbal and motor participation of each participant to the discussion, and information about the time passed since the last speech of each participant. These data allows the tutor, in the moments when he/she will have to moderate a discussion, to adequately manage his/her interlocutors, moderating the excesses of participation and stimulating possible less active participants.

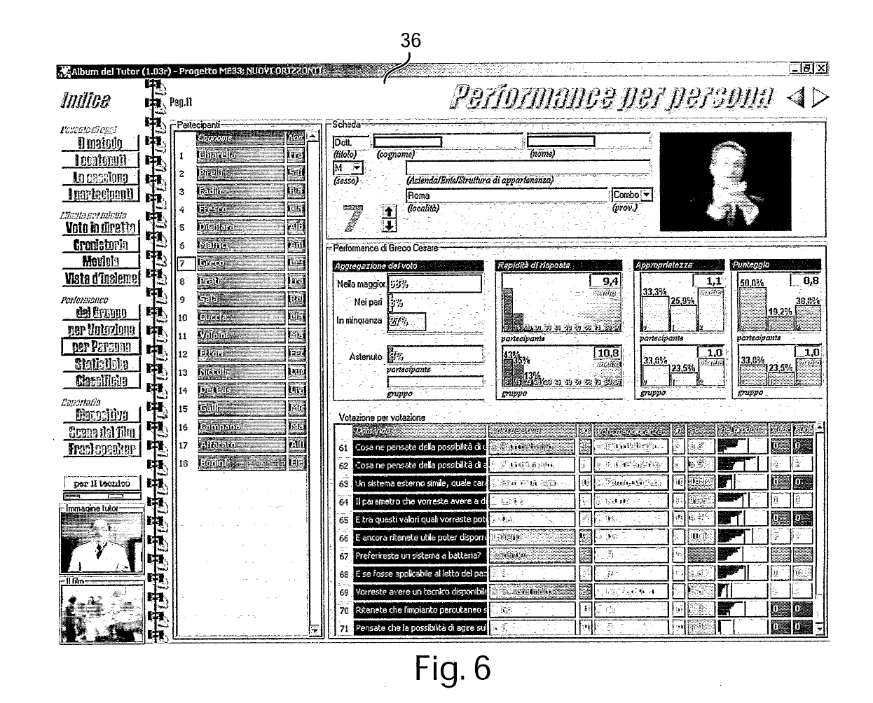

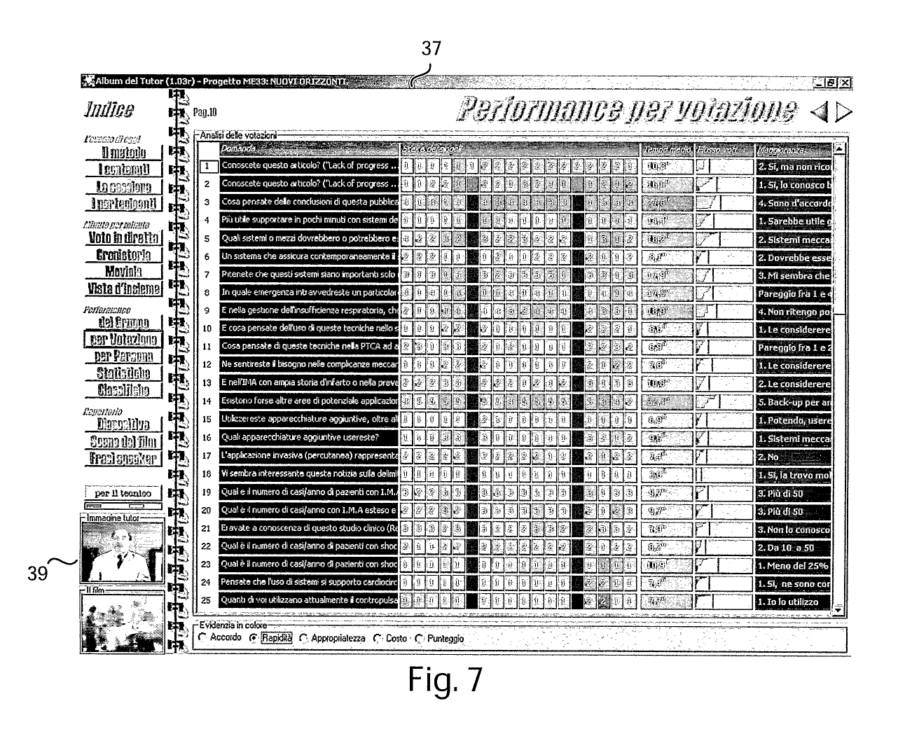

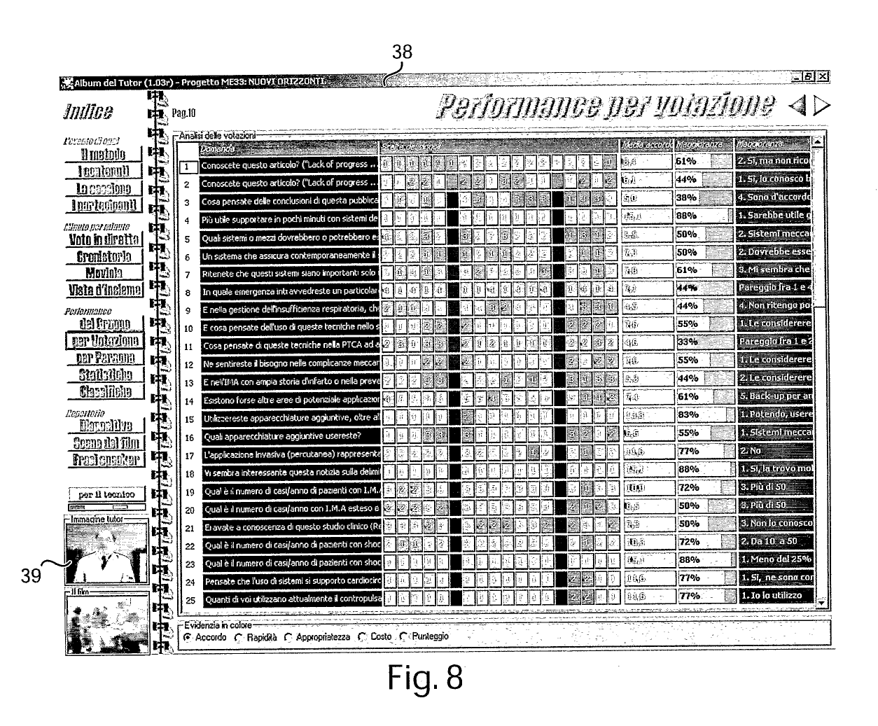

The display of the third server 3 at which the tutor operates may further show all the expressed vote selections, both by individuals, as shown by the interface 36 of FIG. 6, and by majority, as shown by the interfaces 37 and 38 of FIGS. 7 and 8, respectively, in each one of the decisional moments of the interactive movie. Advantageously, such interfaces are suitably coloured so as to make them more immediately comprehensible.

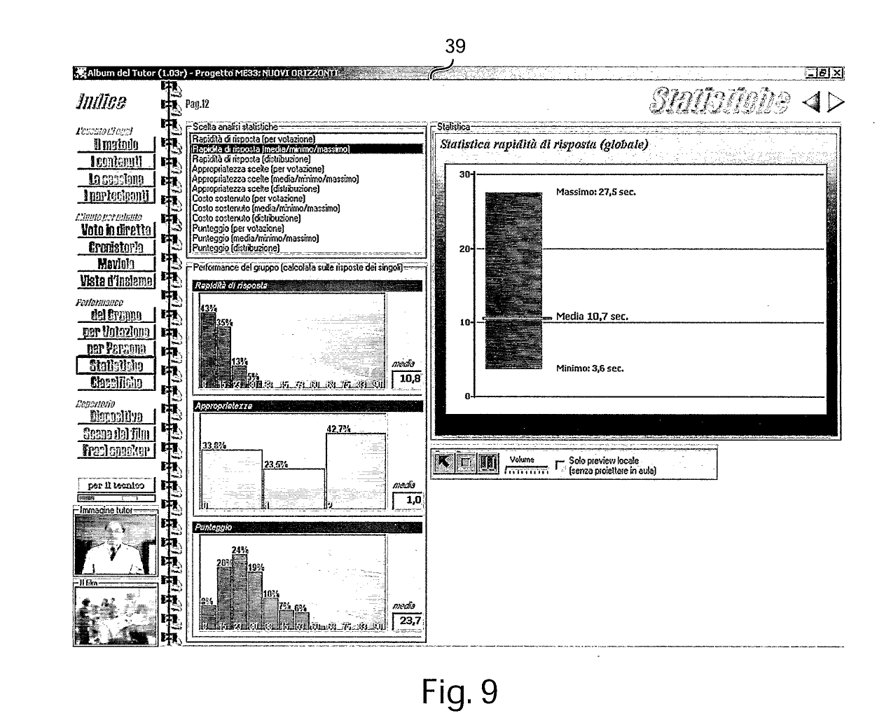

During performance of the exercise, through a data processing performed by the third server 3 and/or by the main server 1 and/or by the communications server 2, the system prepares for the tutor a series of session summarising and/or statistical data, such as those shown by the interface 39 of FIG. 9, summarising the decisional route of the seminar and provides evaluations of the group performance, as indexes of appropriateness, agreement, and response rapidity, so allowing him/her, in case of his/her speech, to have a projectable visual trace to which the same speech refers. Statistics may be visible by selecting the related interfaces, or, in the case when the tutor has not familiarity with computers, they may be orally recalled, through a speech recognition application, and/or they may be automatically periodically shown onto the display of the third server 3.

Preferably, the tutor actively speaks in the seminar, through the microphone and the telecamera with which the third server 3 is provided, only during the final part thereof (although he/she may also speak during the supply of the seminar, for instance for clarifying possible doubts and answering questions). This allows to obtain the maximum reproducibility of the educational message, and to eliminate the influence that possible speeches of the tutor made during seminar delivery would have on the measurement of the grade of student knowledge and mastery of the subject tackled by the seminar. During the interactive seminar, the tutor has hence the opportunity to concentrate on the analysis of the student group, on the instructive needs arising on the basis of the behaviours of the same group, on the decisional routes, on the topics arising during the voting discussion, on the errors or inappropriateness made by the students in managing practical cases shown by the interactive movie. Preferably, when images coming from the telecamera of the third server 3 are projected onto the screen 5, the interface displayed on the third server 3 warns the tutor through a suitable text (as shown in FIG. 5, where it is written “TUTOR IN ONDA!”, that is “TUTOR UNDER SHOT!”).

The teacher is thus able to integrate exercise educational contents with final experience contributions, providing for a seminar personalisation that however does not invalidate the reproducibility of the same seminar achieved through the exercise automatism. During this phase, the tutor may require, through the interface 30 displayed by the third server 3, the projection in the room of contents, which may be both static, in the case when they have been prepared during the production of the seminar (for instance images, movies, slides), and dynamic, in the case when they show session summarising and/or statistical data. The tutor may examine such contents before they are shown in the room.

In particular, session statistical and/or summarising data may comprise: participant performances in making the requested selections, in relation to the agreement grade (indicated, for instance, as the ratio between the number of participants who have voted a same selection with respect to the number of participants who have voted the majority selection), the response rapidity (that may give indications of leadership of individuals who most rapidly makes selections), the appropriateness of the selections made (indicating the response correctness), the economical cost that the selection would entail in the reality (for instance, the cost of selected medical prescriptions, in case of medical seminars), the majority percentage, wherein data may refer to participants considered both individually and wholly as a group, and the single questions (i.e. the single menu of selectable options). In particular, statistical data may also provide a leadership index of each participant that may depend, besides on the response rapidity (a priority in making selections is a sign of leadership), also on the verbosity (a high verbosity is a sign of leadership) and/or on the motility (a low motility during the discussion is a sign of leadership) and/or on the appropriateness of the selections made.

The detail level of summarising data provided by the third server 3 may arrive at displaying the time curve of the selections made by the participants, as shown by the last-but-one right column of FIG. 7. Moreover, the various fields of the interfaces showing summarising and/or statistical data (for instance those of FIGS. 6-9) are advantageously selectable so as to modify, for instance, the vote the results of which are displayed, and to enlarge specific detail squares (for instance histograms) of information contained within the selected field.

Moreover, the teacher may again follow, always by interacting with suitable buttons of the plurality 31 present within the main interface 30 (advantageously also kept within the other interfaces), the decisional routes chosen by the group, or even virtually follow decisional routes which have been either not chosen or chosen by participant minority, in order to examine the consequences of each one of the possible behaviours.

Advantageously, the system according to the invention is provided with an audio control apparatus comprising one or more unit (cooperating with each other) placed on the main server 1 and/or the communications server 2 and/or the logical device of the same interaction unit 6. The main server 1 controls the speakers 8 through this apparatus for diffusing the whole of the audio signals comprising the audio of the interactive movie and the microphone signals coming from the third server 3 and from the interaction units 6. To this end, the audio control apparatus, provided with a mixing device or mixer, is provided with one or more sound intensity control devices (gates/limiters), capable to ensure that the sound intensity constantly remains within a range of good audibility and enjoyment, eliminating peaks and disturbances generated by tone unevenness among different speakers, by sudden approaches to/departures from the microphones, and by possible environmental disturbances.

Moreover, the audio signal of the interactive movie is preferably handled by a digital processor (spectral enhancer), with which the main server 1 is provided, that increases the sensation of immersion and surround, in favour of a stronger cinestetic involvement of the students. Finally, the audio control apparatus is provided with telephone devices, preferably placed on the communications server 2, capable to diffuse in the room the voice connection with possible remote tutors, and to transmit to the same the mixed set of the room audio signals.

Still with reference to FIG. 1, the preferred embodiment of the system according to the invention provides that the main server 1 and the communications server 2 are housed within the same transportable parallelepiped housing, preferably provided with wheels and having size of cm 35×45×45, sharing a display, a keypad, and a mouse (advantageously placed on one or more extractable planes which make them easily accessible). In particular, the operator controlling the operation of the whole system has an electronic switch for connecting the display, the keypad, and the mouse to the main server 1 or to the communications server 2 so as to be capable to select the server with which to interact.

With reference to FIGS. 10 and 11, it may be observed that the main server 1 displays on an interface 40 a first square 41 wherein the interactive movie is shown. In particular, the first square 41 of FIG. 10 shows a phase of the interactive movie displaying a two-option menu 42 illustrated by a character in a corresponding sub-square 43, while the first square 41 of FIG. 11 shows a successive sub-movie of the interactive movie. Moreover, the interface 40 shows a set 44 of selectable buttons and fields for the audio and video control of the movie projection and for monitoring votes made by the participants, a second square 45 for controlling the connections and for monitoring the status of the interactive movie, a third square 46 for monitoring in detail the status of the interactive movie, a fourth square 47 for displaying the branches of the logical tree of the interactive movie which are followed, and a fifth square 48 for displaying some synthetic statistical information on the decisions made by the participants.

With reference to FIG. 12, it may be observed that the communications server 2 preferably displays on a corresponding interface 50 the data coming from each interaction unit 6. In particular, for each interaction unit 6 the images 52 coming from the telecamera are displayed, on a corresponding square 51 (shown in greater detail in FIG. 13), along with four fields 53-56 respectively indicating (for instance through a numerical value and/or a colour) the video operating status (or the participant motility, indicated for instance with a green or orange colour depending on whether the corresponding motility is higher or lower than the motility average MM), the value of the audio signal at the microphone, the value of the processed audio signal indicating the participant verbosity (for instance with a green or orange colour depending on whether the corresponding delay D is shorter or longer than the delay average DM), and the vote instantaneously selected by the participant. In particular, the interface 50 also displays: a square 57 of configuration of the interaction units 6, provided with buttons and fields for setting, for instance, type and number of units 6; a square 58 for setting the Internet Protocol, or IP, addresses of the main server 1 and of the communications third server 3; a square 59 wherein what is projected onto the screen 4 is shown; a square 60 wherein the enlarged mages coming from the telecamera of a unit 6 (selectable by the operator and/or automatically selected for showing the participant who is speaking in that moment) are shown; and a square 61 for showing the images coming from the third server 3, related to the tutor.

In other words, the images of all the telecameras of the interaction units 6 are visible, within the squares 51, simultaneously with the images of the interactive movie, within the square 59, that in each moment is projected by the main server 1 through the projector 4. Moreover, during the moments of discussion, the image of the participant who is speaking in each instant is played through an automatic director (performed by the main server 1 and/or by the communications server 2), within the square 60 (or even within the square 59), allowing the operator to easily follow the discussion flow.

In particular, the configuration of the interaction units 6 may occur through an automatic oral guide, by the communications server 2 and/or through oral guide by the operator interacting with the communications server 2. Such oral guide instructs, through the speakers 8, the individual participants to activate their own unit 6. Alternatively, the guide may be also transmitted via wireless to the headset of a further operator who connects by hand the various units 6 to the network 7.

The interaction units 6 may be also re-configured during seminar supply, for instance after an accidental disconnection. Such re-configuration is preferably automatic and, in particular, it may be provided a system of processing video images and/or audio signals that compares the images and/or the audio signals of the unit 6 to re-configure with the previously stored images and/or audio signals for re-assigning the same identifiers already assigned before the accidental disconnection.

Preferably, the communications server 2 also sends to a video recorder the audio and video data coming from the interaction units 6, so that a permanent audiovisual documentation of each seminar may be maintained.

An uninterruptible power supply, still housed within the housing of the main server 1 and the communications server 2, is capable to temporarily make up for possible interruptions of the mains. Moreover, the housing also comprises a reserve computer, apt to replace the main server 1 or the communications server 2 in case of failures or malfunctions, through a switching system that, although also operatable by an operator, is capable to automatically switch in few fractions of second all the electrical end informatics connections from a possible failed computer to the reserve computer. The housing preferably also comprises one or more dimmers allowing to adjust the light intensity of corresponding external lamps, and control means for orientating the remote telecamera 9. In particular, in case of failure of the main server 1, the communications server 2 or the third server 3 may also operate as main server 1, even assuming the control of the projector 4, through corresponding switches. Similarly, in case of failure of the communications server 2, the main server 1 or the third server 3 may also operate as communications server 2, through corresponding switches.

With reference to FIG. 14, it may be observed that a further embodiment of the system may provide that, most of all in case of a large number of participants, the interaction units comprise only radio devices 18, through which the participants may make selections (and possibly providing for audio signals received from a collar microphone), apt to communicate with a radio concentrator device 19, provided with antenna and connected to the communications server 2 preferably by means of a RS-232 7′ cable (or, alternatively, via USB). The radio concentrator device 19 may be alternatively integrated into the communications server 2. The communications server 2 processes data received, through the radio concentrator device 19, from the radio devices 18, and it is capable to individually set and interrogate the radio devices 18, so as, for instance, to know the charge level of the battery with which each single radio device 18 is provided, and to group among them a plurality of radio devices 18 in a same group, so as to allow an interaction among teams of seminar participants.

Other embodiments of the system according to the invention preferably intended for a number of participants not larger than ten, may comprise, instead of the pair of servers 1 and 2, only one personal computer to which, at most, one telecamera and one or more external voting keypads (possibly connected to corresponding collar microphones) are connected. Such sole personal computer is capable to control the projection of the interactive movie and to interpret the selections made on the external voting keypads.

Preferably according to the invention, the method performed by the system is implemented through a plurality of software programs, installed on the main server 1, on the communications server 2, on the third server 3, on the logical devices of the interaction units 6, and (for the embodiment of FIG. 14) on the radio devices 18 and on the radio concentrator device 19. Most of such software programs is still more preferably implemented with a programming object language, such as for instance Microsoft® C++ and Microsoft® Visual Basic 6.0 languages operating within the Microsoft® Windows operative system.

The present invention has been described, by way of illustration and not by way of limitation, according its preferred embodiment, but it should be understood that those skilled in the art can make variations and/or changes, without so departing from the related scope of protection, as defined by the enclosed claims

1. A system of delivering interactive seminars to one or more participants, comprising a first electronic means, playing on at least one player apparatus at least one movie comprising a set of sub-movies and one or more selection requesting graphic interfaces, said first electronic means being network connected with a second electronic means of interaction of said one or more participants, wherein said first electronic means plays at least one sequence of two or more of said sub-movies conditional on one or more selections made by at least one participant through said second electronic means, at least one of said one or more selections being made at the end of playing a first sub-movie for selecting a second sub-movie within a sub-set of sub-movies corresponding to the first sub-movie, at least one selection requesting graphic interface corresponding to the first sub-movie being displayed at the end of playing the first sub-movie.

2. A system according to claim 1, wherein said second electronic means comprises at least one keypad and/or at least one screen and/or at least one telecamera and/or at least one microphone and/or at least one processing logical device.

3. A system according to claim 1 wherein said second electronic means comprises at least one interaction unit for each one of said one or more participants.

4. A system according to claim 3, wherein said at least one interaction unit comprises:
an alphanumeric keypad,
a liquid crystal screen,
an infrared ray telecamera,
a microphone, and
a processing logical device to which the alphanumeric keypad, the screen, the telecamera, and the microphone are connected
said processing logical device controlling said at least one interaction unit and being connected to said network of connection with said first electronic means, so as to send to this at least one signal depending on one or more signals coming from the alphanumeric keypad and/or from the screen and/or from the telecamera and/or from the microphone.

5. A system according to claim 4, wherein said processing logical device comprises acoustic processing electronic means apt to digitize at least one audio signal coming from the microphone, and to perform operations of gating of said at least one audio signal, so as to at least partially eliminate components thereof different from the components generated by the speech of the related participant.

6. A system according to claim 5, wherein said acoustic processing electronic means at least partially eliminates the components of said at least one audio signal different from the components generated by the speech of the related participant on the basis of their frequency contents and/or of the amplitude of the related signal.

7. A system according to claim 4, wherein said processing logical device comprises video processing electronic means apt to digitize at least one video signal coming from the telecamera.

8. A system according to claim 4, wherein said at least one interaction unit comprises lighting means.

9. A system according to claim 3, wherein said at least one interaction unit comprises a PDA (Personal Digital Assistant).

10. A system according to claim 1, wherein said network of connection of said second electronic means with said first electronic means is at least partially a wired network.

11. A system according to claim 3, wherein said network of connection of said second electronic means with said first electronic means comprises a communications node or hub, to which at least one interaction unit is connected through at least one USB port and/or through the Ethernet network, the hub being connected to or integrated into said first electronic means.

12. A system according to claim 3, wherein said network of connection of said second electronic means with said first electronic means is at least partially a wireless network.

13. A system according to claim 12, wherein said network of connection of said second electronic means with said first electronic means is at least partially a Bluetooth or Wi-fi wireless network.

14. A system according to claim 12, wherein said at least one interaction unit communicates with at least one radio concentrator device, provided with an antenna and connected to or integrated into said first electronic means.

15. A system according to claim 1, wherein said network of connection of said second electronic means with said first electronic means is at least partially a geographically distributed network.

16. A system according to claim 1, wherein said first electronic means comprises at least one server.

17. A system according to claim 16, wherein said first electronic means comprises at least two servers connected in a wired and/or wireless network.

18. A system according to claim 17, wherein said network of connection between said at least two servers is at least partially geographically distributed.

19. A system according to claim 1, wherein said first electronic means comprises at least one database storing a plurality of audio phrases and/or still images and/or moving images, and by the fact that said first electronic means are apt to recognise, on the basis of one or more signals coming from said second electronic means, a context of participation of said one or more participants and to play at least one audio phrase and/or at least one image stored in said at least one database which correspond to the recognised context.

20. A system according to claim 19, wherein the participation contexts which said first electronic means are apt to recognise comprise the end of playing of said first sub-movie and/or the simultaneous presence of at least two vocal signals generated by corresponding participants and/or a determined verbosity index of at least one participant and/or a determined motility index of at least one participant and/or at least one occurred selection made by a participant.

21. A system according to claim 1, wherein said first electronic means plays said second sub-movie by randomly selecting it within a class of sub-movies of the sub-set of sub-movies corresponding to the first sub-movie, said class corresponding to said one or more selections made by at least one participant through said second electronic means.

22. A system according to claim 1, wherein said first electronic means are apt to process summarising and/or statistical data of the delivered interactive seminar.

23. A system according to claim 22, wherein said summarising and/or statistical data of the delivered interactive seminar comprise performances of said one or more participants in making the required selections, in relation to at least one agreement index and/or to at least one response rapidity index and/or to at least one index of appropriateness of the made selections and/or to at least one index of economical cost that the selection would entail in a real situation and/or to at least one majority percentage and/or to at least one verbosity index and/or to at least one motility index and/or to at least one leadership index.

24. A system according to claim 23, wherein said first electronic means comprises at least one storing device for storing said at least one sequence of two or more of said sub-movies and/or said one or more selections made by at least one participant through said second electronic means and/or at least one signal coming from said second electronic means and/or summarising and/or statistical data of the delivered interactive seminar.

25. A system according to claim 24, wherein said first electronic means are apt to manage personal data of said one or more participants.

26. A system according to claim 25, wherein said first electronic means are apt to print summarising and/or statistical data of the delivered interactive seminar on at least one printer.

27. A system according to claim 26, wherein said first electronic means are apt to configure said second electronic means.

28. A system according to claim 27, wherein said first electronic means comprises one or more dimmers for controlling one or more lamps.

29. A system according to claim 28, wherein said first electronic means are apt to control at least one telecamera.

30. A system according to claim 17 wherein said first electronic means comprises:
a main server, apt to control said at least one player apparatus;
a communications server, apt to communicate with said second electronic means, and
a third server, provided with a microphone and/or an infrared ray telecamera, through which a tutor interacts with the system,
the communications server being connected to the main server and to the third server, the main server playing said at least one sequence of two or more of said sub-movies conditional on one or more selections made by at least one participant, on the basis of one or more signals coming from said second electronic means and routed by the communications server, the main server being apt to play on said player apparatus at least one audio signal and/or at least one video signal coming from the third server and routed by the communications server, the third server receiving through the communications server signals coming from the main server and/or from said second electronic means and playing images and/or sounds corresponding to the received signals on at least one display and/or an acoustic player.

31. A system according to claim 30, wherein the main server is provided with one or more reading units for high capacity magnetic cartridges and/or one or more DVD player units and/or one or more hard disks storing the interactive movie in digital format.

32. A system according to claim 30, wherein the main server is apt to display on at least one display at least one selectable graphic interface provided with one or more selectable fields and/or squares for controlling playing of said at least one sequence of two or more of said sub-movies.

33. A system according to claim 30, wherein the communications server is apt to display on at least one display at least one selectable graphic interface provided with one or more selectable fields and/or squares for controlling said second electronic means and/or the main server and/or the third server.

34. A system according to claim 30, wherein the main server and the communications server are apt to be alternatively connected to the same display through an electronic switching device.

35. A system according to claim 30, wherein the third server plays on said at least one display and/or said at least one acoustic player said images corresponding to the signals received according to a plurality of selectable graphic interfaces, preferably comprising one or more selectable fields and/or squares.

36. A system according to claim 30, wherein the third server is provided with at least one memory unit containing a, preferably low-resolution, copy of the interactive movie of which it displays the images in synchronism with what played by the main server on said at least one player apparatus.

37. A system according to claim 30, wherein said at least one player apparatus comprises at least one display and at least one acoustic player.

38. A system according to claim 30, wherein said at least one player apparatus comprises at least one projector, apt to project images onto at least one screen, and one or more speakers for diffusing audio signals.

39. A system according to claim 38, comprising at least two interaction units arranged according to a horseshoe open towards at least one screen.

40. A system according to claim 38, wherein said at least one projector is a liquid crystal digital video projector.

41. A system according to claim 38, wherein said at least one projector operates in retro-projection behind at least one screen.

42. An interaction apparatus, comprising at least one keypad and/or at least one screen and/or at least one telecamera and/or at least one microphone and/or at least one processing logical device, wherein said interaction apparatus is apt to be used as an interaction unit in a system of delivering interactive seminars to one or more participants,
wherein said system comprises:
a first electronic means playing on at least one player apparatus at least one movie comprising a set of sub-movies and one or more selection requesting graphic interfaces,
said first electronic means being network connected with a second electronic means of interaction of said one or more participants, said second electronic means comprising at least one interaction unit, which is the interaction apparatus, for each one of said one or more participants,
wherein said first electronic means plays at least one sequence of two or more of said sub-movies conditional on one or more selections made by at least one participant through said second electronic means, at least one of said one or more selections being made at the end of playing a first sub-movie for selecting a second sub-movie within a sub-set of sub-movies corresponding to the first sub-movie, at least one selection requesting graphic interface corresponding to the first sub-movie being displayed at the end of playing the first sub-movie.

43. A system computer, apt to control at least one player apparatus, wherein said system computer is apt to be used as a main server in a system of delivering interactive seminars to one or more participants wherein said system comprises:
a first electronic means playing on said at least one player apparatus at least one movie comprising a set of sub-movies and one or more selection requesting graphic interfaces,
said first electronic means being network connected with a second electronic means of interaction of said one or more participants wherein said first electronic means plays at least one sequence of two or more of said sub-movies conditional on one or more selections made by at least one participant through said second electronic means, at least one of said one or more selections being made at the end of playing a first sub-movie for selecting a second sub-movie within a sub-set of sub-movies corresponding to the first sub-movie, at least one selection requesting graphic interface corresponding to the first sub-movie being displayed at the end of playing the first sub-movie,
said first electronic means comprising at least two servers connected in a wired and/or wireless network, said at least two servers comprising:
the main server, which is the system computer;
a communications server, apt to communicate with said second electronic means; and
a third server provided with a microphone and/or an infrared ray telecamera, through which a tutor interacts with the system,
the communications server being connected to the main server and to the third server,
the main server playing said at least one sequence of two or more of said sub-movies conditional on one or more selections made by at least one participant, on the basis of one or more signals coming from said second electronic means and routed by the communications server,
the main server being apt to play on said at least one player apparatus at least one audio signal and/or at least one video signal coming from the third server and routed by the communications server,
the third server receiving through the communications server signals coming from the main server and/or from said second electronic means and playing images and/or sounds corresponding to the received signals on at least one display and/or an acoustic player.

44. A system computer, apt to communicate with an interaction electronic means (also referred to herein as a second electronic means), wherein said system computer is apt to be used as a communications server in a system of delivering interactive seminars to one or more participants wherein said system comprises:
a first electronic means playing on at least one player apparatus at least one movie comprising a set of sub-movies and one or more selection requesting graphic interfaces,
said first electronic means being network connected with said second electronic means of interaction of said one or more participants wherein said first electronic means plays at least one sequence of two or more of said sub-movies conditional on one or more selections made by at least one participant through said second electronic means, at least one of said one or more selections being made at the end of playing a first sub-movie for selecting a second sub-movie within a sub-set of sub-movies corresponding to the first sub-movie, at least one selection requesting graphic interface corresponding to the first sub-movie being displayed at the end of playing the first sub-movie,
said first electronic means comprising at least two servers connected in a wired and/or wireless network, said at least two servers comprising:
a main server, apt to control said at least one player apparatus;
the communications server, which is the system computer; and
a third server provided with a microphone and/or an infrared ray telecamera, through which a tutor interacts with the system,
the communications server being connected to the main server and to the third server,
the main server playing said at least one sequence of two or more of said sub-movies conditional on one or more selections made by at least one participant, on the basis of one or more signals coming from said second electronic means and routed by the communications server,
the main server being apt to play on said at least one player apparatus at least one audio signal and/or at least one video signal coming from the third server and routed by the communications server,
the third server receiving through the communications server signals coming from the main server and/or from said second electronic means and playing images and/or sounds corresponding to the received signals on at least one display and/or an acoustic player.

45. A system computer, provided with microphone and/or infrared ray telecamera, wherein said system computer is apt to be used as a third server in a system of delivering interactive seminars to one or more participants, wherein said system comprises:
a first electronic means playing on said at least one player apparatus at least one movie comprising a set of sub-movies and one or more selection requesting graphic interfaces,
said first electronic means being network connected with a second electronic means of interaction of said one or more participants wherein said first electronic means plays at least one sequence of two or more of said sub-movies conditional on one or more selections made by at least one participant through said second electronic means, at least one of said one or more selections being made at the end of playing a first sub-movie for selecting a second sub-movie within a sub-set of sub-movies corresponding to the first sub-movie, at least one selection requesting graphic interface corresponding to the first sub-movie being displayed at the end of playing the first sub-movie,
said first electronic means comprising at least two servers connected in a wired and/or wireless network, said at least two servers comprising:
a main server, apt to control said at least one player apparatus;
a communications server, apt to communicate with said second electronic means; and
the third server, which is the system computer, through which a tutor interacts with the system,
the communications server being connected to the main server and to the third server,
the main server playing said at least one sequence of two or more of said sub-movies conditional on one or more selections made by at least one participant, on the basis of one or more signals coming from said second electronic means and routed by the communications server,
the main server being apt to play on said at least one player apparatus at least one audio signal and/or at least one video signal coming from the third server and routed by the communications server,
the third server receiving through the communications server signals coming from the main server and/or from said second electronic means and playing images and/or sounds corresponding to the received signals on at least one display and/or an acoustic player.

46. A method of delivering interactive seminars to one or more participants, comprising:
controlling through a first electronic means the playing on at least one player apparatus of at least one movie comprising a set of sub-movies and one or more selection requesting graphic interfaces;
the method being at least one sequence of two or more of said sub-movies is conditional on one or more selections made by at least one participant through second electronic means connected to said first electronic means, at least one of said one or more selections being made at the end of playing of a first sub-movie for selecting a second sub-movie within a sub-set of sub-movies corresponding to the first sub-movie, at least one selection requesting graphic interface corresponding to the first sub-movie being displayed at the end of playing of the first sub-movie.

47. A method according to claim 46, wherein said first electronic means are apt to recognise, on the basis of one or more signals coming from said second electronic means, a context of participation of said one or more participants and to play at least one audio phrase and/or at least one image stored in at least one database.

48. A method according to claim 47, wherein the participation contexts which said first electronic means are apt to recognise comprise the end of playing of said first sub-movie and/or the simultaneous presence of at least two vocal signals generated by corresponding participants and/or a determined verbosity index of at least one participant and/or a determined motility index of at least one participant and/or at least one occurred selection made by a participant.

49. A method according to claim 47, wherein said first electronic means performs the following steps:
periodically controlling, at a rate equal to a period CP, said one or more signals coming from said second electronic means;
processing said controlled one or more signals for recognising a corresponding context, and, in the case when the recognised context belongs to a class of contexts to be subject to periodical control:
randomly or pseudo-randomly selecting at least one audio phrase and/or at least one image to play within a class of audio phrases and/or images corresponding to the recognised context.

50. A method according to claim 49, wherein said at least one audio phrase and/or at least one image to play is selected on the basis of an historical memory of the previously played audio phrases and/or images.

51. A method according to claim 49, wherein said at least one audio phrase and/or at least one image to play is selected in the case when said first electronic means has randomly or pseudo-randomly checked whether to play at least one audio phrase and/or at least one image corresponding to the context or not.

52. A method according to claim 47, wherein, in the case when said first electronic means recognises the participation context as belonging to a class of contexts to be subject to immediate control, said first electronic means selects at least one audio phrase and/or at least one image to play within a class of audio phrases and/or images corresponding to the recognised context.

53. A method according to claim 52, wherein the context recognised as belonging to a class of contexts to be subject to immediate control is a context in which all said one or more participants have made at least one selection, said first electronic means reproducing the results of the selections.

54. A method according to claim 52, wherein said context recognised as belonging to a class of contexts to be subject to immediate control is a context in which a maximum time has passed since the display of said at least one selection requesting graphic interface, said first electronic means reproducing the results of the selections.

55. A method according to claim 54, wherein for at least one participant who has made no selection, said first electronic means automatically generates a selection, randomly and/or on the basis of at least one previously made selection.

56. A method according to claim 53 wherein said first electronic means reproduces the results of the selections in the case when a significant majority of selections exists, otherwise it selects at least one audio phrase and/or at least one image to play for inviting to make new selections.

57. A method according to claim 46 wherein said first electronic means are apt to calculate, on the basis of one or more signals coming from said second electronic means, at least one verbosity index of at least one participant.

58. A method according to claim 57, wherein said at least one verbosity index of at least one participant is calculated as a function of at least one parameter selected from the group comprising:
the time average of duration,
the amplitude, and
the total duration, of at least one audio signal generated by the speeches of said at least one participant.

59. A method according to claim 58, wherein said time average of duration of said at least one audio signal generated by the speeches of said at least one participant is calculated within at least one time window of duration W.

60. A method according to claim 57 wherein said at least one verbosity index of at least one participant is calculated as a function of a mean and/or total number of the speeches of said at least one participant.

61. A method according to claim 57, wherein said at least one verbosity index of at least one participant is calculated as a function of a time delay D, equal to the time passed since the last speech of said at least one participant.

62. A method according to claim 61, wherein said at least one verbosity index of said at least one participant is calculated as the difference of said time delay D with respect to an average DM of the time delays of said one or more participants.

63. A method according to claim 58, wherein said at least one audio signal generated by the speeches of said at least one participant is neglected if its intensity is lower than a minimum threshold A.

64. A method according to claim 58, wherein a speech of said at least one participant is neglected if its duration is shorter than a minimum time threshold T1, preferably equal to 4 seconds.

65. A method according to claim 64, wherein one or more interruptions of said at least one audio signal occurring within a speech of said at least one participant are neglected if their duration is shorter than a maximum time threshold T2, preferably equal to 3 seconds.

66. A method according to claim 58, wherein said at least one audio signal generated by the speeches of said at least one participant is processed so as to subtract an audio signal played by said at least one player apparatus therefrom.

67. A method according to claim 58 wherein said at least one audio signal generated by the speeches of said at least one participant is processed on the basis of its frequency contents and/or its amplitude.

68. A method according to claim 58 wherein said first electronic means are apt to perform a step of learning of the frequency spectrum and/or the mean amplitude of said at least one audio signal generated by the speeches of said at least one participant.

69. A method according to claim 46 wherein said first electronic means are apt to calculate, on the basis of one or more signals coming from said second electronic means, at least one motility index of at least one participant.

70. A method according to claim 69, wherein said at least one motility index of at least one participant is calculated, starting from the images detected from a telecamera taking said at least one participant, depending on at least one difference, between two successive instant images, of at least one value depending on at least one parameter selected from the group comprising:
chrominance,
luminance, and
intensity of at least one video signal generated by said telecamera.

71. A method according to claim 70, wherein the calculation of said at least one motility index of at least one participant comprises the following steps:
A. for each instant image, the instant image is subdivided into areas of N×N pixels, wherein preferably N=8 or 16;
B. for each area of the instant image under consideration:
A.1 calculating a value depending on the average and/or the sum of at least one of the three signals of chrominance, luminance, and intensity;
A.2 calculating the difference VD between the value calculated in step A.1 and the value of the corresponding area of the instant image immediately preceding that under consideration;
A.3 in the case when the difference calculated in step A.2 is higher than a minimum threshold value MV, considering the corresponding area as a mobile area;
C. calculating a value of instant motility of the participant depending on the number of mobile areas of the instant image under consideration;
D. calculating a value of whole motility of the participant depending on the value of instant motility of the participant calculated in step C.

72. A method according to claim 71, wherein said instant motility value of the participant calculated in step C is equal to the number of mobile areas of the instant image under consideration.

73. A method according to claim 71, wherein said whole motility value of the participant calculated in step D is equal to the time average of the instant motility.

74. A method according to claim 69, wherein said at least one motility index of said at least one participant is calculated as the difference of a whole motility of said at least one participant with respect to an average MM of the whole motilities of said one or more participants.

75. A method according to claim 70, wherein said at least one video signal generated by said telecamera is processed so as to subtract the background of said images therefrom.

76. A method according to claim 70, wherein said at least one video signal generated by said telecamera is processed so as to track at least one portion of said images occupied by said at least one participant.

77. A method according to claim 70, wherein said first electronic means are apt to perform a step of learning of said at least one video signal generated by said telecamera is processed so as to recognize at least one portion of said images occupied by said at least one participant.
